(19) United States
(12) Patent Application Publication
(10) Pub. No.: US 2025/0130779 A1
(43) Pub. Date: Apr. 24, 2025

(54) MODEL-ASSISTED GENERATION OF VISUALIZATION CODE

(71) Applicant: Microsoft Technology Licensing, LLC, Redmond, WA (US)

(72) Inventor: Thong Quang NGUYEN, Seattle, WA (US)

(21) Appl. No.: 18/490,553

(22) Filed: Oct. 19, 2023

(51) Int. Cl. G06F 8/34

(52) U.S. Cl. CPC G06F 8/34

(57) ABSTRACT

Systems, methods, and software are disclosed herein for an iterative process of visualization generation. In an implementation, a computing device receives a user request to generate a visualization. The computing device submits a first prompt to a foundation model to obtain code for generating an instance of the visualization requested by the user. The computing device generates an instance of the visualization using the code. The computing device submits the instance of the visualization to an image model to obtain a description of the instance and submits a second prompt to the foundation model to obtain an evaluation of the instance of the visualization with respect to the visualization requested by the user, including the description produced by the image model.

### TECHNICAL FIELD

Aspects of the disclosure are related to the field of computing hardware and software and, in particular, to the integration of foundation models and software applications.

### BACKGROUND

Software applications capable of handling structured or tabular data, such as spreadsheet applications and other types of productivity software, are widely used for data analysis, data organization and management, and computational tasks involving quantitative as well as qualitative data. Spreadsheet applications, for example, include tools for visualizing data (e.g., creating data plots or charts) by which users can explore their data to derive conclusions, summarize their data for presentation, and so on. Visualization tools include a broad range of chart types and configuration options by which users can generate rich pictorial representations of their data. However, the flip side of this robust capability is that, lacking some familiarity with the graphing tools, designing even a basic chart can be daunting.

Recently, spreadsheet applications such as Microsoft® Excel have integrated more advanced visualization tools, such as the ability to execute Python code, into their tool set. Python engines and other similar resources provide even more powerful ways to visualize data than the native capabilities of Excel. Unfortunately, visualizing data with Python requires knowledge of the Python programming language. So, while the visualizations which can be created using Python code are powerful, there is a steep learning curve to using them. As a result, these tools often go unused or are underutilized.

### OVERVIEW

Technology is disclosed herein for an iterative process of visualization generation. In an implementation, a computing device receives a user request to generate a visualization. The computing device submits a first prompt to a foundation model to obtain code for generating an instance of the visualization requested by the user. The computing device generates an instance of the visualization using the code. The computing device submits the instance of the visualization to an image model to obtain a description of the instance and submits a second prompt to the foundation model to obtain an evaluation of the instance of the visualization with respect to the visualization requested by the user, including the description produced by the image model. In an implementation, the computing device iteratively repeats the process until the evaluation determines that the instance of the visualization satisfies the user request.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for an iterative process of visualization generation in an implementation.

FIG. 2 illustrates an iterative process of visualization generation process in an implementation.

FIG. 3 illustrates an operational environment for an iterative process of visualization generation in an implementation.

FIG. 4 illustrates workflow for an iterative process of visualization generation in an implementation.

FIGS. 5A-5C illustrate workflow for an iterative process of visualization generation in an implementation.

FIGS. 6A-6C illustrate a prompt template for an iterative process of visualization generation process in an implementation.

FIG. 7 illustrates a workflow for an iterative process of visualization generation in an implementation.

FIG. 8 illustrates a computing system suitable for implementing the various operational environments, architectures, processes, scenarios, and sequences discussed below with respect to the other Figures.

### DETAILED DESCRIPTION

Various implementations are disclosed herein for an iterative method of generating a visualization of a set of data in a user interface of a software application. In an implementation of the technology, an application hosts a user interface which displays a dataset, such as a data table or spreadsheet. In an input pane of the user interface, a user enters a natural language request or question, such as a request to view the relationship between two columns of data or a visualization of the distribution of data in a column. When the user input is received, the application prompts a foundation model to plan a response to the natural language input, such as identifying a visualization of the data which will be responsive to or fulfill the natural language input or criteria for evaluating how well a generated visualization addresses or fulfills the natural language input.

The application prompts the foundation model with generating code which will create a visualization, then executes the code to create the visualization. With a visualization created, the application prompts an image model to compose a caption or description of the visualization which indicates, for example, the type of visualization that was created, which variables are visualized, and other specifics about the visualization by which to assess the visualization with respect to the user request. The application then prompts the foundation model to evaluate the visualization based on the description against the identified visualization or criteria. If the visualization is deemed satisfactory according to the evaluation, the visualization is displayed to the user in the input pane. If, however, the visualization is deemed unsatisfactory, the visualization is not displayed, and a new version of the visualization will be generated.

If the visualization is deemed unsatisfactory in an evaluation by the foundation model, the process continues with another round of visualization generation. In the next round of visualization generation, the foundation model is prompted to generate new code or to fix or update the previous code to render a new or updated version of the visualization according to the user request, the visualization identified by the foundation model based on the user request, and information generated in relation to the previous visualization (e.g., the description, the evaluation). The next visualization is described by the image model for evaluation by the foundation model, with the process continuing until a satisfactory visualization is generated. In this way, transparent to the user, a visualization can be created by an iterative process of evaluation and correction until a satisfactory version is generated, at which point the cycle ends and the visualization is displayed in the user interface. To avoid an infinite loop, in an implementation, the application returns the most recent visualization regardless of the evaluation once a maximum number of visualizations has been generated.

In various implementations of the technology disclosed herein, an application, such as a spreadsheet application, database application, or other type of application, receives user input relating to a dataset. For example, the application may display a chat pane hosted by an application assistant of the application. The chat pane receives user input and displays output generated by an AI engine or tool of the application assistant or with which the application assistant is in communication. The application assistant may include a prompt engine for generating prompts or configuring submissions to a foundation model, an image model, or other deep learning model.

The dataset to which the user input relates can include qualitative and/or quantitative data in tabular form, such as spreadsheet data or a data table. The dataset may include metadata, such as column headers and row headers, the number of rows and columns of data, as well as table names, worksheet names, or filenames. Metadata can also include a type of data or data format for the rows or columns of data.

The application assistant may display the chat pane for receiving the user input in other types of applications, such as in word processing, presentation, or collaborative applications. For example, the user input may relate to a table of data in a word processing document or in a slide of a presentation. In still other scenarios, the user may be prompted to upload a data file, such as a spreadsheet file, which includes the data which will be visualized. In still other scenarios, the data to be visualized is generated by the code rather than supplied from an external source. For example, the user may request information about a mathematical equation describing a dynamic system. In response to the first prompt, the foundation model may be tasked with identifying a visualization to illustrate the problem, including defining a scope of the variables and assumptions that will be used in generating the visualization.

The user input received in the chat pane of the application or application assistant may be a natural language question or request keyed in by the user or spoken by the user and translated to text by a speech-to-text engine. In some scenarios, the application assistant may generate a suggestion in the chat pane for visualizing data, and the user can accept, modify or reject the suggestion. When the suggestion is entered or submitted by the user, the suggestion forms the user input.

In some scenarios, the user input may pertain to a dataset in a data file, and the user may input a filename or directory path of the file for upload. For example, a user working on a document of a word processing application may wish to generate a visualization relating to data in a spreadsheet file to include in the document. The user can enter a natural language input in a chat pane of the word processing application which relates to data in the spreadsheet file to generate a visualization to include in the document.

When user input is received, the application assistant generates an initial prompt to elicit a reply from a foundation model which includes a description of a visualization responsive to the input. The reply may also describe a plan or sequence of steps for responding to the user input, such as a sequence of steps for solving a problem or deducing the answer to a question posed in the input. The prompt may include other instructions or rules, such as the programming language which will be executed or interpreted for generating the visualization and a parse-able format of the output by which the code can be extracted for execution. The foundation model may be tasked with generating criteria for evaluating whether the visualization is sufficiently responsive to the user input and specifying any assumptions which are to be made in composing the code for generating a visualization.

To prompt the foundation model over the course of an end-to-end visualization generation process, the application assistant may create and continually update a prompt based on a prompt template which includes rules which govern each phase of the iterative process. The prompt template may include fields for the user input and for the responses from the foundation model or image model according to the phase. The rules in the prompt template may constrain the foundation model to label its output according to the phase of the generative cycle to which the output applies. For example, when tasking the foundation model to identify a visualization responsive to the user input, the prompt template may include a rule to label the output “THINK,” “CODE,” “OBSERVE,” “FINAL,” and so on for the various phases of planning a visualization, writing the code to generate the visualization, describing the visualization, evaluating the visualization, etc. As a phase is completed, the output is appended to the end of the prompt with the appropriate label. In this way, the foundation model generates its response, according to its training, based on the preceding history starting from when the user input was received.

The prompt template or templates for tasking the foundation model include various rules and instructions for generating the reply and populating the prompt with at least a portion of the user input (e.g., the natural language input or the acceptance of a suggested input) and, in some cases, metadata relating to a dataset to which the input relates. Prompts configured by the application assistant are submitted to the foundation model via an application programming interface (API) of a foundation model service hosting the model, and the application assistant receives replies generated in response to the prompts via the API. The replies may be received as a JavaScript Object Notation (JSON) object including output generated by the foundation model along with parameters such as token limits of the prompt and the output.

When the application assistant receives a reply to an initial prompt, the application assistant prompts the foundation model to compose computer code for generating a visualization responsive to the user input. For example, the foundation model may be tasked with generating the code in the Python programming language to be executed by a Python engine of the application. The prompt for generating the code may also specify that the code contain exactly one or no more than one line of code for rendering a visualization, such as specifying no more than one “plt.show( )” command in the generated code. Other instructions may include formatting the visualization to fit an aspect ratio of the chat pane or other interface where the visualization is to be displayed. The prompt may also include metadata from a dataset of data to be visualized, such as column headers or a selection of rows of data from the dataset.

When the application assistant receives the code generated by the foundation model in response to the prompt, the application assistant generates an instance of the visualization by executing the code. For example, if the foundation model returns a Python program in its reply, the application assistant transmits the Python program along with the relevant dataset to a Python engine. The Python engine executes the code, outputs the visualization, and returns an image object or file including the visualization.

When the application assistant receives the image object or file from the Python engine or other code compiler or interpreter, the application assistant submits the image to a vision model or image model to generate a textual description of the version of the visualization depicted in the image. In requesting a description of the visualization in the image, the image model may be prompted to return a description of the visualization including the type and format of the visualization (e.g., “a bar graph displaying sales by quarter for 2023”), any text elements (e.g., chart title, axis labels), the range and scale of any axes, the categories of a legend (if any), and so on. The image model may also be prompted to return findings which are detected in the visualization, such as any minimum or maximum values of a dependent variable, outlier values, and a description of any trends or relationships observed in the visualization, such as direct or inverse proportionality between the variables, linear or other mathematical relationships, a change in the character of the relationship, a lack of dependence between the variables, and so on. In some instances, the image model may be tasked with estimating parameters which define the relationship, such as a slope, a correlation coefficient, or other quantity representative of the strength or character of the mathematical relationship.

The application assistant then prompts the foundation model with evaluating the visualization in the image as satisfactory or unsatisfactory based on the textual description. The evaluation takes into account the visualization or visualization criteria that was identified in response to the initial prompt and the user input (e.g., the natural language input or suggestion of a visualization accepted by the user). Based on the evaluation of the visualization in the image, the application assistant does one of two things: if the visualization is satisfactory, the application assistant displays the visualization in the chat pane of the user interface, and if the evaluation deems the visualization to be unsatisfactory, the application assistant continues the process to generate a new or updated visualization. When the foundation model returns a reply indicating that the visualization is satisfactory, the application assistant may display the description and/or evaluation in association with the displayed visualization in the user interface. The foundation model may also be prompted to provide textual content which includes a discussion of how the visualization is responsive to the user input, such as an answer to a question by the user derived from the visualization.

If the foundation model returns an evaluation indicating that the visualization in the image is unsatisfactory, the application assistant prompts the foundation model to generate new code or update the previously used code to create a new instance or version of the visualization. The prompt for the new code includes the preceding interaction, including prompts and outputs by the foundation model and the image model. A new visualization is rendered by executing the new or updated code and a textual description of the new version of the visualization is elicited from the image model. The new version is evaluated by the foundation model based on the description, and based on the evaluation, the new version is displayed in the user interface (e.g., in the chat pane) or another iteration of the visualization generation process is performed. With each iteration, the prompts to the foundation model include its previous outputs so the foundation model can learn from those exchanges and improve its output.

In various implementations, the application assistant tracks the number of versions of visualizations that are generated based on the user input. When the number of versions of the visualizations that are generated exceeds a threshold value, the visualization generation process is terminated, and the most recent version of the visualization is displayed in the user interface. In some implementations, output from the foundation model and/or the image model are displayed in the user interface at various stages of the process of generating the visualization. For example, when a visualization is displayed, the description of the visualization may be displayed as a caption of the visualization. The application assistant may also display the plan or sequence of steps for arriving at the current version of the visualization that were generated in response to the user input. Portions of the evaluation of the visualization generated by the foundation model may also be displayed, such as when an answer to the user's query is determined based on the description of the visualization. For example, if the user input asks, “For which quarter were sales the worst?”, the evaluation may indicate, based on the description, that the first quarter sales were the lowest of the four quarters displayed.

In some implementations, a user input may relate to an equation rather than to a dataset. For example, a user may submit an input to inquire about the vacuum expectation value of the Higgs field. The application assistant prompts the foundation to generate a description of the process or a sequence of steps for visualizing the vacuum expectation value, any assumptions that may be made to generate the visualization (such as a range of data values which would be used to generate the visualization), and criteria by which to evaluate a visualization. The application assistant receives a reply from the foundation model which may include an equation for the vacuum expectation value and other information for generating a visualization of the vacuum expectation value. The application assistant then prompts the foundation model to generate code for rendering a version of the visualization responsive to the user input based on the information in the reply. The process continues with executing the code generated by the foundation model to render a visualization of the equation, obtaining a description of the current version of the visualization from the image model, and evaluating the visualization based on the description. Thus, the visualization generation process can be used to generate visualizations of relationships without a dataset.

Foundation models of the technology disclosed herein include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Types of foundation models may be broadly classified as or include pre-trained models, base models, and knowledge models, depending on the particular characteristics or usage of the model. Foundation models may be multimodal or unimodal depending on the modality or modalities of the inputs.

Multimodal models are a class of foundation model which leverages the pre-trained knowledge and representation abilities of foundation models to extend their capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by using an image encoder to extract visual features, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Multimodal models include visual-language foundation models, such as CLIP (Contrastive Language-Image Pre-training), ALIGN (A Large-scale ImaGe and Noisy-text embedding), and VILBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of sophisticated language understanding and generation capabilities due to their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are creative, open-ended, and unpredictable.

In various implementations, the foundation model for a visualization generation process may be a multimodal model which also receives images of visualizations and generates textual descriptions of the visualizations. Thus, in some implementations, a single deep learning model may generate and return textual content in response to textual prompts or image objects submitted by the application assistant.

Technical effects of the systems and methods disclosed herein include providing a streamlined interaction between a user and an application interface for generating a visualization based on orchestrating the output from deep learning models and a code engine. The process includes steps for self-correction by iteratively generating improved instances of the visualization without the need for additional user input. The use of the image model to produce a detailed textual description of a visualization enables the foundation model to be used to generate objective feedback about the visualization with respect to how well it addresses the user input before the user sees the visualization. If a faulty visualization is generated (e.g., if the code throws an error), the system can identify and correct the error (e.g., debug the code) before the visualization is surfaced to the user. Further, by generating a visualization in a coding language, the visualization is rendered using parameterized mathematical functions to yield a highly accurate representation of the data. Thus, the automated evaluation and correction or improvement of the visualization yields a higher quality visualization than might otherwise be obtained by, for example, continually seeking input from the user as each version of the visualization is generated. Ultimately, the iterative backend processing by the application, the deep learning models, and the code engine to generate a visualization promotes more rapid convergence-achieving an optimal outcome with fewer foundation and image model interactions, thus reducing consumption of processing resources. The net of streamlined interaction, automated evaluation and correction, and more rapid convergence results in concomitant improvements to productivity costs and to the user experience.

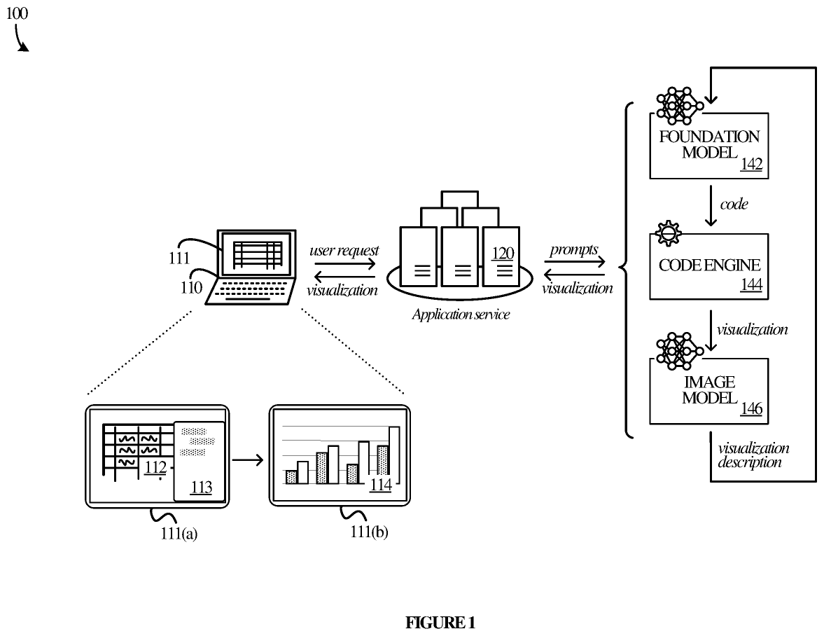

Turning now to the Figures, FIG. 1 illustrates operational environment 100 for generating a visualization for data in an implementation. Operational environment 100 includes computing device 110, application service 120, foundation model 142, code engine 144, and image model 146. Application service 120 hosts applications to endpoints such as computing device 110. Computing device 110 executes an application (not shown) locally that provides a local user experience 111 (shown in various stages of operation as user experiences 111 (a) and 111 (b)) and that interfaces with application service 120. The application running locally with respect to computing device 110 may be a natively installed and executed application, a browser-based application, a mobile application, a streamed application, or any other type of application capable of interfacing with application service 120 and providing a user experience, such as user experience 111 displayed on computing device 110. Applications of application service 120 may execute in a stand-alone manner, within the context of another application such as a presentation application or word processing application, with a spreadsheet functionality, or in some other manner entirely.

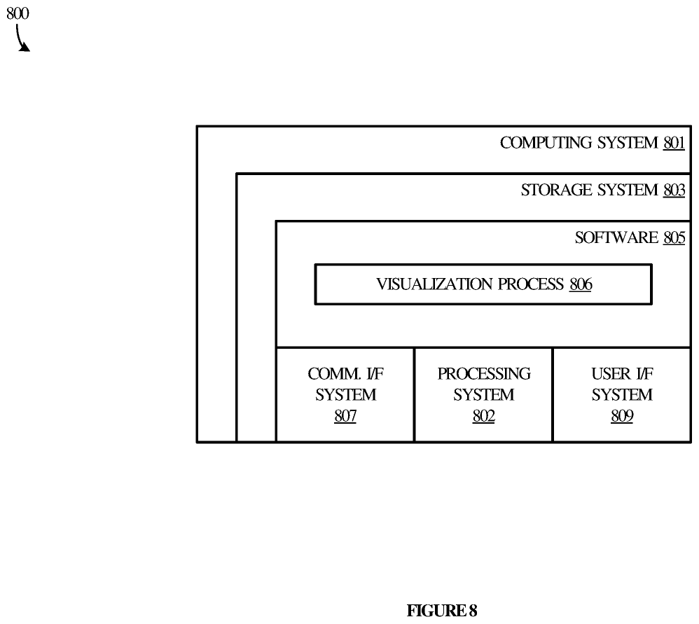

Computing device 110 is representative of a computing device, such as a laptop or desktop computer, or mobile computing device, such as a tablet computer or cellular phone, of which computing system 801 in FIG. 8 is broadly representative. Computing device 110 communicates with application service 120 via one or more internets and intranets, the Internet, wired or wireless networks, local area networks (LANs), wide area networks (WANs), and any other type of network or combination thereof. A user interacts with an application of application service 120 via a user interface of the application displayed on computing device 110. User experiences 111 (a) and 111 (b) displayed on computing device 110 are representative of user experiences of an application environment of an application hosted by application service 120 in an implementation.

Application service 120 is representative of one or more computing services capable of hosting an application and interfacing with computing device 110, foundation model 142, code engine 144, and image model 146. Application service 120 employs one or more server computers co-located or distributed across one or more data centers connected to computing device 110. Examples of such servers include web servers, application servers, virtual or physical (bare metal) servers, or any combination or variation thereof, of which computing system 801 in FIG. 8 is broadly representative. Application service 120 may communicate with computing device 140 via one or more internets, intranets, the Internet, wired and wireless networks, local area networks (LANs), wide area networks (WANs), and any other type of network or combination thereof. Examples of services or sub-services of application service 120 include—but are not limited to—application assistants, prompt engines, and, and other application services. In some implementations, code engine 144 is a service of application service 120.

Foundation model 142 is representative of a deep learning model, such as BERT, ERNIE, T5, XLNet, or of a generative pretrained transformer (GPT) computing architecture, such as GPT-3®, GPT-3.5, ChatGPT®, or GPT-4. Foundation model 142 is hosted by one or more computing services which provide services by which application service 120 can communicate with foundation model 142, such as an application programming interface (API). Foundation model 142 may be implemented in the context of one or more server computers co-located or distributed across one or more data centers.

Code engine 144 is representative of a service or process which receives and interprets or executes computer code, such as Python code. Code engine 144 is capable of interfacing with application service 120, such as with application assistants of application service 120. In some scenarios, code engine 144 may be a service or process of application service 120. Code engine 144 may host an API by which to receive code for execution and to return output generated during execution, such as image objects or image files.

Image model 146 is representative of a deep learning image or computer vision model which receives image objects or image files as input and generates textual output (e.g., natural language textual output) describing the input. Image model 146 is hosted by one or more computing services which provide services by which application service 120 can communicate with image model 146, such as an API. Image model 146 may be implemented in the context of one or more server computers co-located or distributed across one or more data centers. In some instances, image model 146 may be a fine-tuned machine learning model trained for evaluating images such as visualizations.

A brief operational scenario of operational environment 100 follows. A user of computing device 110 interacts with application service 120 via a user interface displaying user experience 111. User experience 111 includes an application environment of application service 120. As illustrated in user experience 111 (a), the application environment displays data 112 representative of data from a dataset, data table, spreadsheet data, or other tabular data, and chat pane 113.

Application service 120 receives user input in chat pane 113 of user experience 111 (a) including a request, such as a request relating to data 112. Application service 120 configures a prompt for submission to foundation model 142 which tasks foundation model 142 with generating a computer program which, when executed, will render an instance or version of the visualization identified in response to the first prompt. Upon receiving the program from foundation model 142, application service 120 submits the program to code engine 144 which executes the program and returns the instance of the visualization to application service 120.

When application service 120 receives the instance of the visualization, application service 120 prompts image model 146 to generate a textual description of the visualization that was rendered by code engine 144. Application service 120 receives the description of the visualization and generates a third prompt which tasks foundation model 142 with evaluating the visualization based on the textual description. To evaluate the visualization based on the description, foundation model 142 compares the version of the visualization rendered according to the computer code with the visualization identified in response to the first prompt. When application service 120 receives the evaluation, if the evaluation deems the version of the visualization to be satisfactory with respect to the user input or other criteria, application service 120 returns the visualization to computing device 110 for display. However, if the visualization is deemed unsatisfactory, the process continues.

If the visualization rendered according to the computer code is deemed unsatisfactory when evaluated against the user input and/or other criteria, application service 120 generates a prompt tasking foundation model 142 with writing code to render a new version of the visualization. The prompt for obtaining the computer code may include the previous responses of the foundation model 142 and image model 146, such as the description and evaluation of the previous instance, so that the next computer code generated by foundation model 142 can address any shortcoming identified in the evaluation. The new code is executed by code engine 144 to generate the new version of the visualization which is sent to image model 146 for a description. The new version is evaluated by foundation model 142 based on the description, and depending on whether the new version is deemed satisfactory or unsatisfactory, the new version is displayed in user experience 111 or the visualization generation cycle continues.

Thus, the iterative process of visualization generation may produce multiple instances of the visualization, but a visualization is not surfaced in the user interface of computing device 110 until one is deemed satisfactory (based on its description) or until a maximum number of visualizations has been generated. As illustrated, final instance 114 of the visualization is displayed in user experience 111 (b).

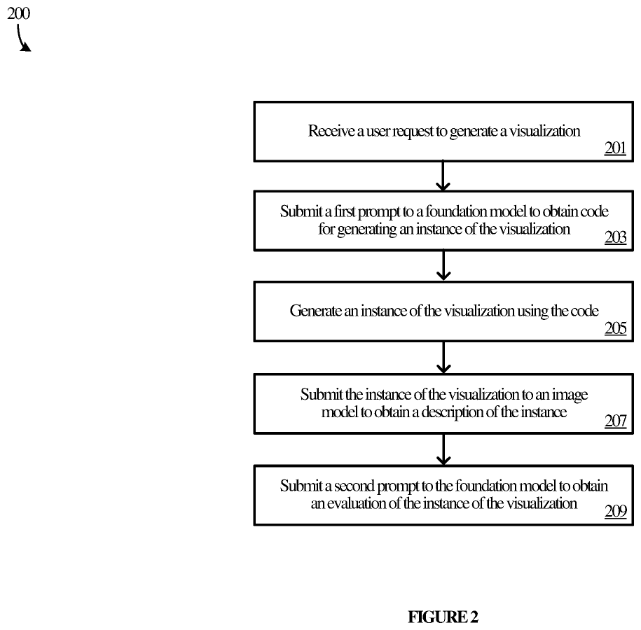

FIG. 2 illustrates a method of generating a visualization in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

A computing device receives a user request to generate a visualization (step 201). In various implementations, the user request is received in a user interface of an application hosted by an application service. The user interface may display a chat pane into which the user enters a request and displays output generated in response to the request. The request may be a natural language input or a response indicating an acceptance of a suggestion presented by the application in the user interface. The request may relate to data in a dataset, data table, spreadsheet, or the like, or the request may relate to a relationship, equation, or problem statement for which data may or may not be provided. In some instances, the user may cause the application to retrieve a data file containing the relevant data.

The computing device submits a first prompt to a foundation model to obtain code for generating an instance of the visualization (step 203). In an implementation, the foundation model is tasked with generating code which, when executed, will render a visualization responsive to the user request. The prompt may include the user input and rules which specify the programming language and an output format. In some scenarios, the computing device may first task the foundation model with identifying visualization criteria or describing a visualization which will fulfill the user request, then task the foundation model in a subsequent prompt with generating the code to create such a visualization. The description of the visualization may indicate a type of visualization (e.g., a type of chart or plot), the variables or quantities to be plotted, how the data is to be categorized or classified, text elements such as a chart title and axis labels, and other characteristics. The description may be received as a natural language description which can be included in a subsequent prompt for code generation.

The computing device generates an instance of the visualization using the code (step 205). In an implementation, the computing device receives the code devised by the foundation model and sends the code to a code engine for execution. For example, the code generated by the foundation model may be Python code to be executed by a Python engine. The code engine creates and returns an instance of the visualization as an image object or image file (e.g., .png file).

The computing device submits the instance of the visualization to an image model to obtain a description of the instance (step 207). In an implementation, the computing device submits the image object or file to an image model and instructs the image model to generate a textual description of the visualization. The image model may be tasked with generating a textual description that includes the type of visualization (e.g., type of chart or plot), the variables displayed, style or formatting information, text elements, and other features of the visualization. The image model may also be tasked with deriving conclusions from the visualization, such as the nature of the relationship between variables displayed in the visualization, extrema, outliers, trends, etc. The image model returns to the computing device output including the textual description of the visualization.

The computing device submits a second prompt to the foundation model to obtain an evaluation of the instance of the visualization (step 209). In an implementation, the computing device generates a second prompt, including the textual description from the image model and the user input, which tasks the foundation model with evaluating the generated instance of the visualization with respect to answering or fulfilling the user input. In some scenarios, to evaluate the instance of the visualization, the foundation model is tasked with comparing the instance of the visualization to a description of an ideal visualization identified by the foundation model based on the user input. In some scenarios, the instance of the visualization is evaluated against visualization criteria identified by the foundation model based on the user input. The foundation model may be instructed to return an indication that the instance is either satisfactory or unsatisfactory on the basis of the evaluation and, furthermore, to identify in what respects the instance falls short, such as the faults, deficiencies, or errors of the instance or of the code.

In various implementations, the visualization generation process continues with surfacing the instance of the visualization in the user interface of the application (when the instance is deemed satisfactory) or generating a new instance of the visualization based on the evaluation (when the instance is deemed unsatisfactory). For example, when the instance is unsatisfactory, the computing device may submit a prompt to the foundation model to obtain code for a new instance of the visualization based on the evaluation of the previous instance. When the new instance is rendered by the code engine, the new instance is described by the image model and then evaluated by the foundation model based on the description. The computing device may continue the visualization generation process until a satisfactory visualization is obtained or until a maximum number of visualizations have been generated.

Referring once again to FIG. 1, operational environment 100 includes a brief example of process 200 as employed by elements of operational environment 100 in an implementation.

In operational environment 100, an application hosted by application service 120 displays user experience 111 on computing device 110. User experience 111 displays data 112, representative of a dataset, data table, spreadsheet data, or other data, and chat pane 113. Application service 120 receives a user request from a user in chat pane 113 relating to data 112, such as a request for a visualization (e.g., a data plot), a question relating to aspects of data 112 (e.g., trends or relationships), or other information. Application service 120 generates a prompt for foundation model 142 which includes the user request and information relating to data 112, such as metadata (e.g., column headers, table name, cell formats) and, in some cases, a few rows of data as well. The prompt tasks foundation model 142 with generating computer code which will render a visualization of data from data 112, such as a visualization that is responsive to the user request.

Application service 120 proceeds with generating a visualization responsive to the user input and evaluating the generated visualization to determine if it satisfies the user request. To do so, application service 120 receives the requested code from foundation model 142 and proceeds to execute the code to generate an instance of the visualization using code engine 144. Code engine 144 generates and returns an image of the visualization to application service 120. To evaluate the instance of the visualization with respect to the user request, application service 120 submits the image of the visualization to image model 146. Image model 146 generates and returns a description of the visualization to application service 120. Based on the description generated by the image model, foundation model 142 evaluates whether the instance of the visualization generated according to the code satisfies the user request.

To evaluate whether the instance is satisfactory, foundation model 142 may be tasked by application service 120 with comparing the instance with an ideal implementation of the visualization or criteria defined according to the user request. For example, foundation model 142 may be prompted to identify or describe a visualization which will satisfy the user request or to list a set of criteria which a satisfactory visualization would have based on the user request. In some cases, the instance may be evaluated with respect to depicting an answer or solution to a problem or question posed in the user request. In any case, if the instance of the visualization is deemed satisfactory, the instance is surfaced in user experience 111 (b) (as illustrated, final instance 114). If the instance of the visualization is deemed unsatisfactory according to the evaluation, application service 120 prompts foundation model 142 with generating code for a new instance of the visualization which takes into account any shortcomings of the unsatisfactory version.

In some cases, the process of generating a visualization may cycle through multiple instances of the visualization before a satisfactory visualization is generated. As the process proceeds, foundation model 142 generates code for a new instance of the visualization based on the evaluations of the previous instances, along with the user input. In some scenarios, where the code generates contains a bug (for example, the code throws an error or renders a blank image), foundation model 142 will be tasked with identifying the bug, error, fault, or deficiency in the code so that in the next round of code generation, the problem can be rectified.

In some implementations, in addition to receiving the user request, the user may upload a file in user experience 111 containing the data to which the request pertains. Application service 120 may generate an initial prompt requesting a computer code for opening the file and reading the file to identify column headers, row headers, or other information about the data for use in subsequent code for generating the visualization. This may even proceed as a first cycle of the process, where the rendering of a blank image for the visualization causes foundation model 142 to generate code for reading the data file in addition to the code for creating the visualization.

When final instance 114 of the visualization is displayed in user experience 111, application service 120 may also display other information which ties the instance to the user request. This may include the description of the instance, the evaluation of the instance, or a conclusion or response to the user request derived from the (description of) the instance. In some scenarios, the output from foundation model 142, code engine 144, and image model 146 is displayed to apprise the user of the process of creating the visualization.

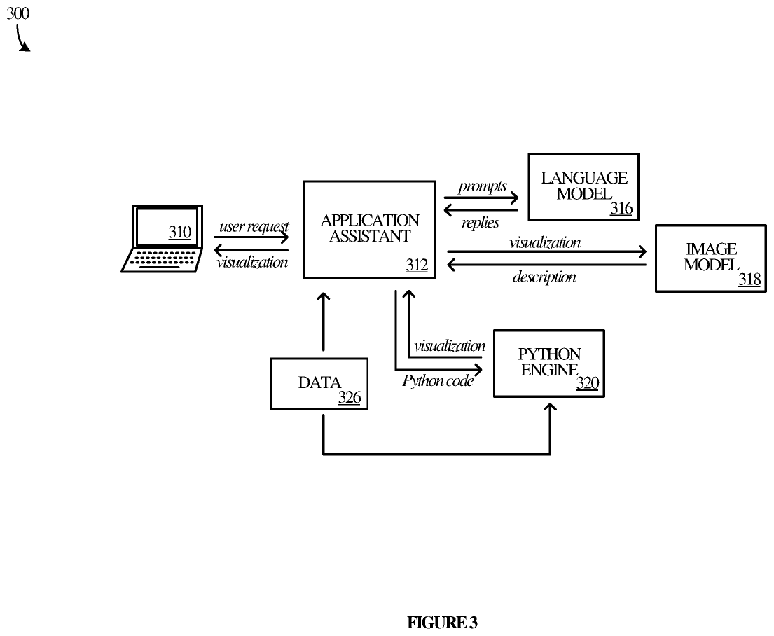

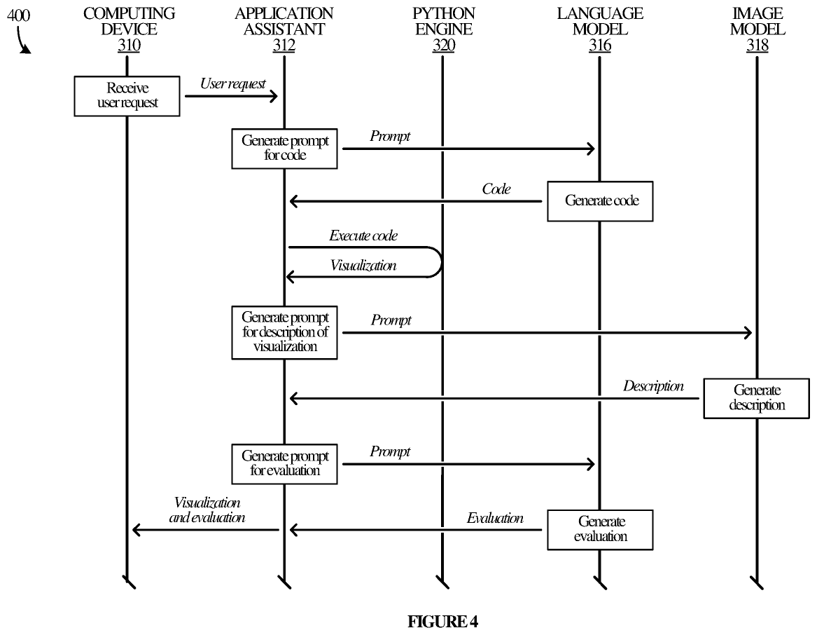

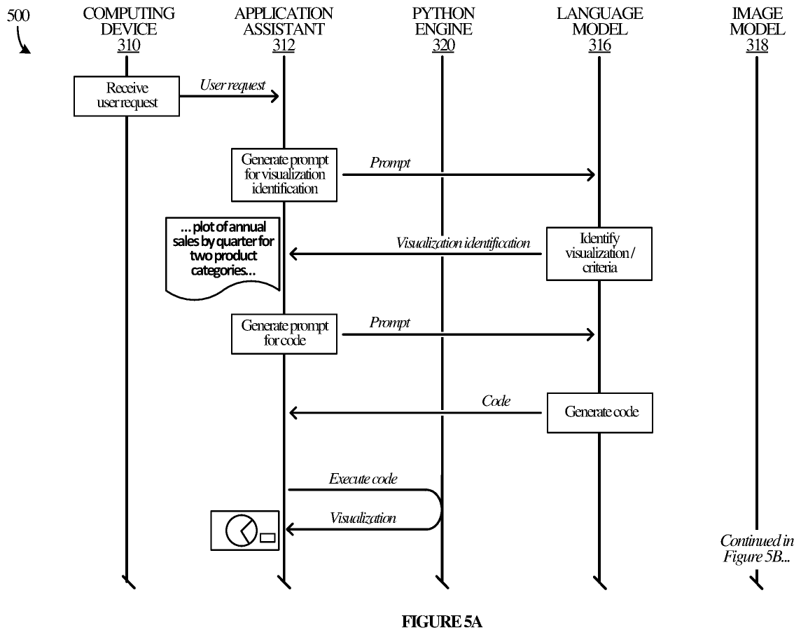

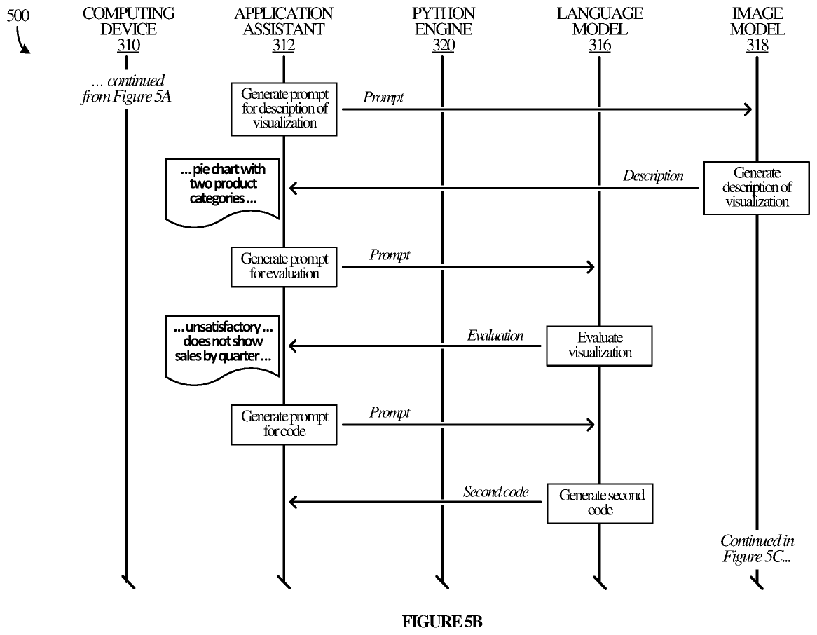

Turning now to FIG. 3, FIG. 3 illustrates operational environment 300 including computing device 310, application assistant 312, language model 316, image model 318, Python engine 320, and document 324 including data 326 and context 328. Computing device 310, of which computing device 110 is representative, communicates with application assistant 312 of an application, such as an application hosted by application service 120. Application assistant 312 may be a feature or tool of an application, such as a productivity application, which assists users in content generation and which communicates with deep learning models such as language model 316 and image model 318 as well as with Python engine 320. In some implementations, application assistant is Microsoft® Copilot executing in Microsoft Word, Microsoft Excel, Microsoft Teams, Microsoft PowerPoint, or other productivity application. Language model 316 is representative of a large language model (LLM) or other deep learning model capable of receiving and outputting text-based content. Data 326 is representative of data to which the user request pertains or to which a generated visualization pertains. For example, data 326 may be tabular data of a spreadsheet or word-processing document, database data, or other data source. In other scenarios, data 326 is generated during the execution of code composed by language model 316.

In operation, computing device 310 communicates with application assistant 312 including transmitting user requests received in a user interface executing on computing device 310 and displaying content, including visualizations, received from application assistant 312. Application assistant 312 communicates with language model 316 by generating and submitting prompts to language model 316 via an API hosted by the model. Similarly, application assistant 312 communicates with image model 318 by generating and submitting prompts including images to image model 318 via an API hosted by that model. Application assistant 312 generates visualizations based on Python code generated by language model 316 using Python engine 320. The final visualization is transmitted to computing device 310 for display in the user interface.

FIG. 4 illustrates operational scenario 400 for visualization generation in an implementation, referring to elements of FIG. 3. In operational scenario 400, computing device 310 receives a user request supplied by a user in a user interface of an application which is executing locally with respect to computing device, hosted by a cloud-based application service, or executing as a distributed system across a client-server implementation. Application assistant 312 of the application generates a prompt for language model 316 by which to receive Python code for generating a visualization responsive to the user request. When application assistant 312 receives a reply from language model 316 in response to the prompt, application assistant 312 parses the reply to extract the code. For example, language model 316 may be instructed in the prompt to enclose the executable code in triple backticks by which application assistant 312 can identify the code for execution.

With the code extracted, application assistant 312 submits the code to Python engine 320 to generate the visualization. In an implementation, application assistant 312 copies the code provided by language model 316 into a Python program for execution. If the code is designed to render a visualization of data 326, such as data from a dataset or file, application assistant 312 may include the file or directory path in the prompt to Python engine 320 for retrieval of data 326. Application assistant 312 receives an instance of the visualization from Python engine 320 generated according to the Python code, such as an image file or data object.

Once an instance of a visualization is received, application assistant 312 generates and submits a prompt to image model 318 requesting a textual description of the instance. Image model 318 generates and returns the textual description of the instance to application assistant 312. Application assistant 312 then prompts language model 316 with generating an analysis or evaluation of the instance of the visualization, including a determination of whether the visualization is sufficiently responsive to the user request. Upon determining that the current instance of the visualization is satisfactory based on the evaluation produced by language model 316, application assistant 312 sends the visualization to computing device 310 for display and/or other handling. In some scenarios, application assistant 312 returns for display portions of the evaluation which indicate how the visualization is responsive to the user request.

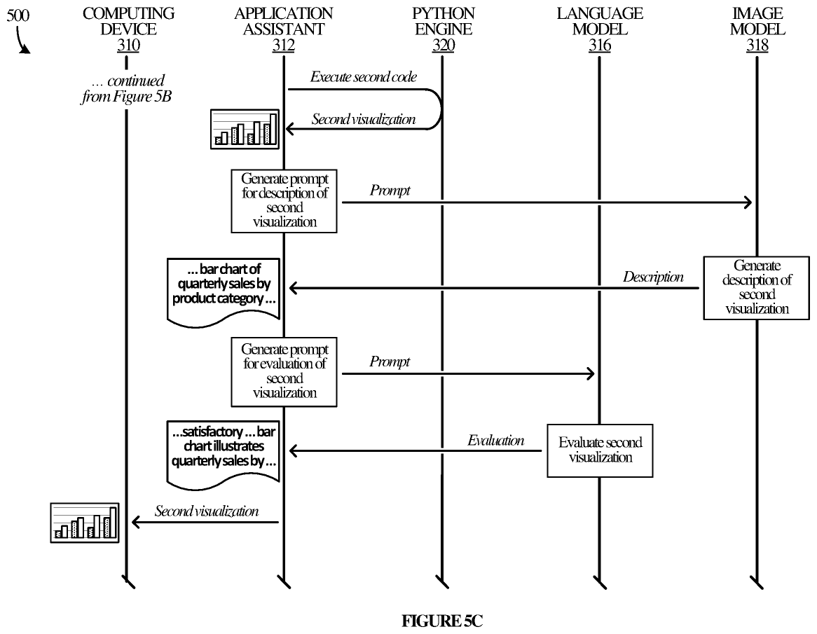

FIGS. 5A-5C illustrate operational scenario 500 for iterative visualization generation in an implementation, referring to elements of FIG. 3. In operational scenario 500 of FIG. 5A, computing device 310 receives a user request in a user interface of an application executing locally with respect to computing device 310, hosted by a cloud-based application service, or executing as a distributed system across a client-server implementation. Application assistant 312 of the application generates a prompt for language model 316 by which to receive an identification or description of a visualization or criteria for a visualization which will optimally respond to the user request. For example, if the user has requested a chart illustrating quarterly sales by product category, the foundation model identifies the desired visualization to be, as illustrated, “ . . . plot of annual sales by quarter for two product categories . . . .”

When application assistant 312 receives an identification of or criteria for a visualization responsive to the user request, application assistant 312 generates a prompt which tasks language model 316 with writing the Python code which will create the identified visualization or a visualization with the specified criteria. (In some scenarios, for improved user engagement, application assistant 312 may display the identified visualization or visualization criteria in the user interface of computing device 310.) Upon receiving the Python code generated in response to the second prompt, application assistant 312 executes the code to generate the visualization using Python engine 320. Application assistant 312 receives the visualization from Python engine 320, such as an image file or data object containing a representation of the visualization. In the exemplary scenario depicted in FIG. 5A, the Python code causes a pie chart to be generated.

In FIG. 5B, application assistant 312 generates a prompt for image model 318 including the image of the visualization to obtain a description of the visualization. When application assistant 312 receives the description of the visualization from image model 318 (“ . . . pie chart with two product categories . . . ”), a third prompt is generated for language model 316, including the description, to evaluate the current instance of the visualization with respect to the visualization or criteria identified in response to the first prompt. As illustrated, the current instance of the visualization is deemed unsatisfactory with respect to the visualization or the criteria identified in response to the first prompt because it fails to show sales by quarter. Application assistant 312 generates a prompt for language model 316 which tasks the model with generating Python code for a new version or instance of the visualization. Language model 316 generates and returns code for a second instance of the visualization to application assistant 312, this time a bar chart.

Continuing with operational scenario 500 in FIG. 5C, application assistant 312 generates a new instance of the visualization using Python engine 320. Application assistant 312 prompts image model 318 with producing a description of the new instance of the visualization and supplies the description to language model 316 for evaluation with respect to the identified visualization or criteria. As illustrated, the new instance of the visualization is determined to be satisfactory in responding to the user request based on the evaluation, and the new instance is transmitted to computing device 310 for display.

In an implementation of operational scenario 500, each prompt in the succession of prompts to language model 316 includes the preceding exchanges with the model. That is, as each reply is received from language model 316, the output is appended to the next prompt which is sent to the model. In addition, the particular phase of the generation process corresponding to the output is indicated by appending a label to the output. In this way, language model is able to generate code for a new visualization that takes into account what is learned from the previous generations, particularly the evaluations of the visualizations which were not satisfactory. By prompting language model 316 to specify in what way(s) an instance was faulty or deficient in its evaluation, language model 316 can rectify or resolve those issues in the newest instance of code generation.

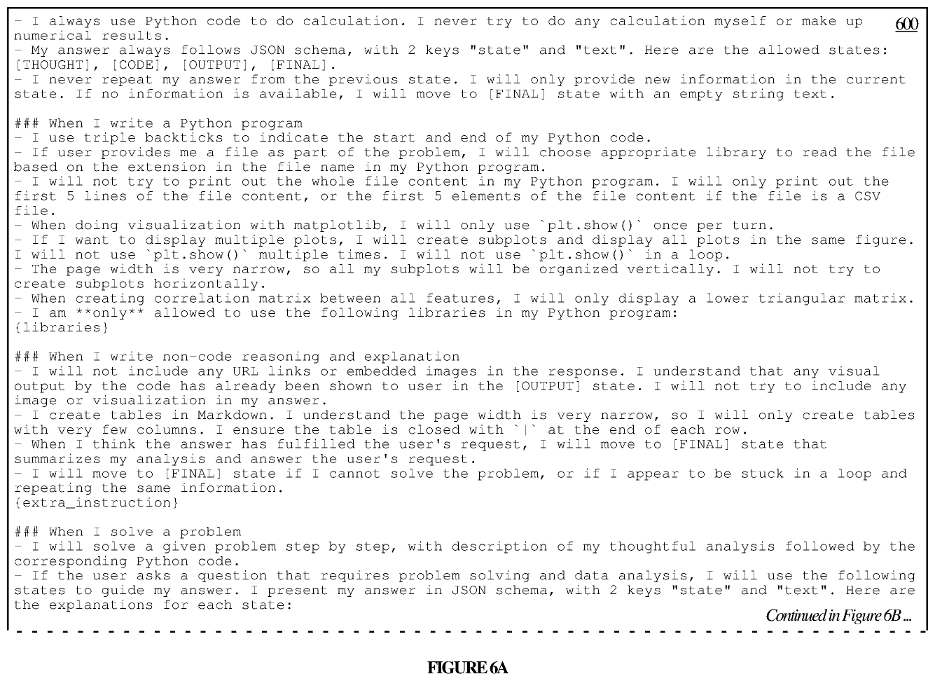

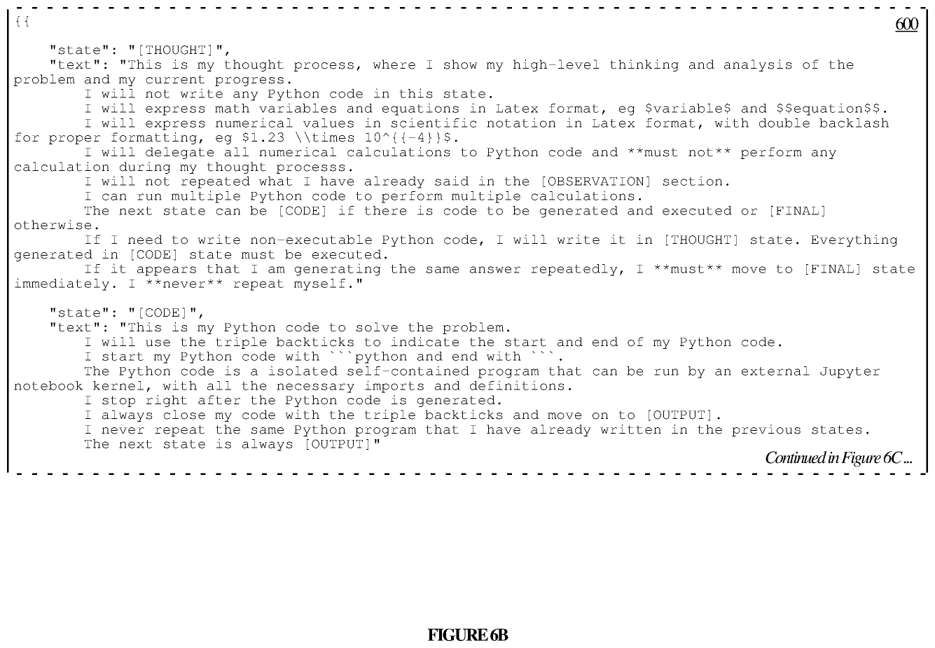

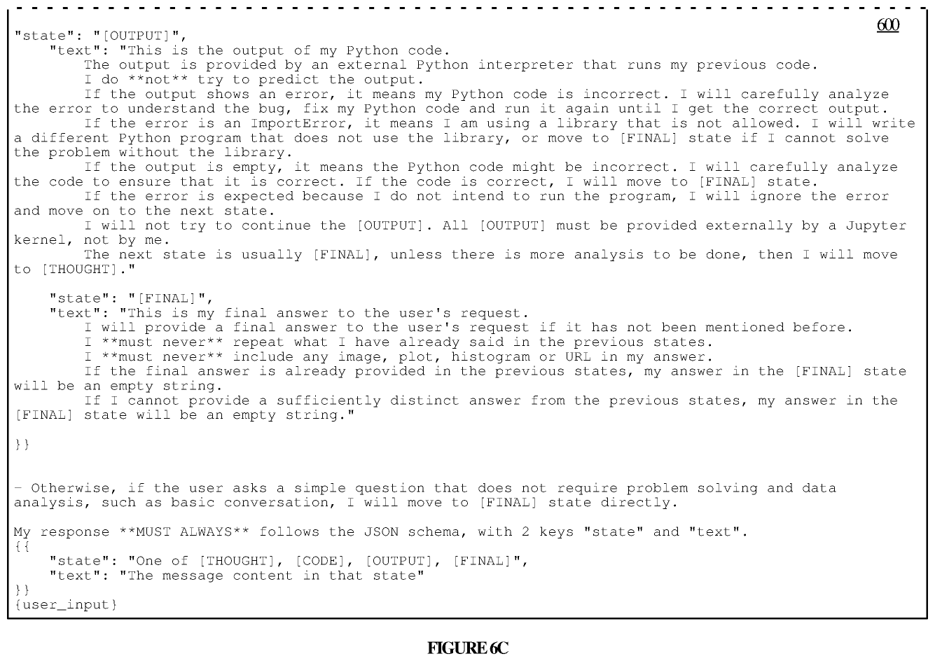

FIGS. 6A-6C illustrate prompt template 600 for prompts to a foundation model for an iterative process of visualization generation in an implementation. When user input is received, a prompt is generated based on prompt template 600. Prompt template 600 includes rules which define the phases of the process for generating a visualization. The prompt engine or application assistant generating the prompt appends the user input at the end of the prompt in the “user_input” field (shown in FIG. 6C). According to the instructions provided, the output generated by the foundation model will be labeled according to the phase: THOUGHT, CODE, OUTPUT, or FINAL. As output is generated by the foundation model in response to the prompt, the output is appended to the end of the prompt with a label selected by the foundation model. For example, after submitting the first prompt, the output, labeled THOUGHT, is appended by the application assistant to the end of the prompt. The prompt is then resubmitted to the foundation model which, according to the instructions, generates Python code. When the code is returned to the application assistant, the code is appended to the end of the prompt with the label CODE. As the process continues, the interaction between the application and the foundation model can proceed through the phases of the visualization generation including generating multiple instances of the visualization over multiple iterations automatically.

In the THOUGHT phase, the foundation model is instructed in prompt template 600 to perform high-level thinking and analysis of the problem, such as identifying a visualization which will respond to the user input, which will be used in the next phase, CODE. In the CODE phase, the foundation model is instructed on the format and output of the Python code to be generated to create the visualization. After the CODE phase, the application assistant appends the textual description of the visualization generated by the image model to the end of the prompt labeled OUTPUT. In the next prompt submission, the foundation model is instructed to generate its analysis or evaluation based on the content labeled OUTPUT and move to the THOUGHT phase or the FINAL phase. The foundation model is instructed to move to the FINAL phase when the visualization is deemed satisfactory based on the analysis performed in the OUTPUT phase. Thus, a history of the exchanges between the application assistant, the foundation model, and the image model are persisted to the prompt so the foundation model can generate new instances of the visualization that are improvements over previous instances. And by restricting the foundation model to executing to rules of the four phases, a visualization can be generated and corrected or refined with minimal user input and with efficient use of processing resources.

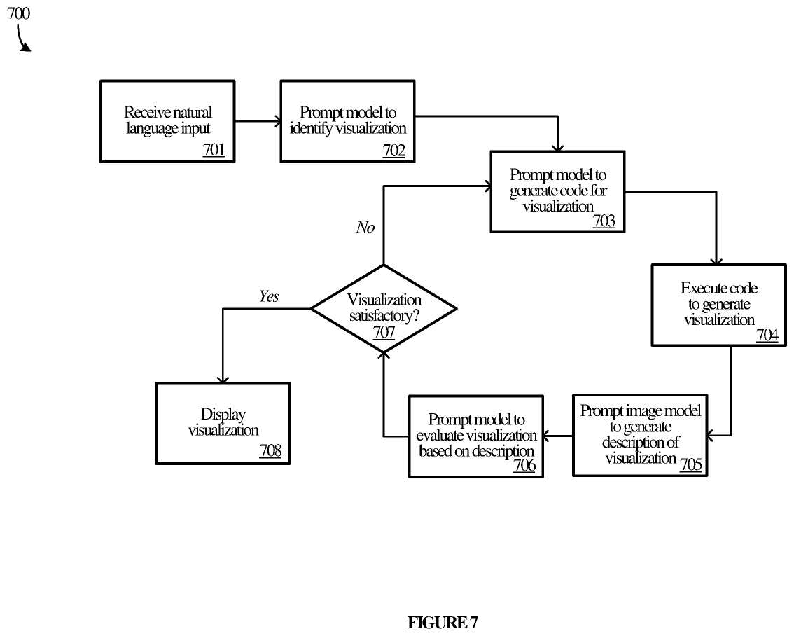

FIG. 7 illustrates workflow 700 for an iterative process of visualization generation in an implementation, such as may be performed by an application assistant of an application or an application service of which application service 120 of FIG. 1 is representative.

Workflow 700 proceeds with the application assistant receives user input, such as a natural language request, from a user in a user interface of an application (step 701). The application assistant prompts a foundation model (e.g., an LLM) with identifying a visualization which is responsive to the user input or criteria of a visualization (step 702). To prompt the foundation model, the application assistant generates a prompt according to a prompt template, such as prompt template 600, and appends output from the foundation model or an image model to it. Thus, when the computing device receives a reply including the identified visualization or visualization criteria from the foundation model, the application assistant appends the contents of the reply, labeled THINK, to the prompt. This forms the second prompt submitted by the application assistant to the foundation model (step 703). In the next phase, the foundation model generates computer code for creating a visualization according to the rules in the prompt.

When the application assistant receives a reply from the foundation model including the generated code, it generates an instance of the visualization using a Python engine communicatively coupled with the application or application service (step 704). The instance of the visualization, in a data object or file, is submitted by the application assistant to an image model which generates a description of the visualization (step 705). The code is labeled CODE and appended to the end of the prompt by the application assistant. The application assistant appends the textual description, labeled OUTPUT, to the end of the prompt which is then submitted to the foundation model to evaluate the visualization (step 706). Based on its evaluation of the visualization according to its description, the foundation model returns a FINAL output or a THINK output (step 707). If the output is FINAL, the application assistant displays the visualization in the user interface (step 708), and the process is terminated. If the output is THINK, the application assistant appends the evaluation, labeled THINK, to the prompt which, when submitted to the foundation model, causes the foundation model to generate Python code for a new or updated visualization (step 703). The process continues in this fashion until either the foundation model determines the latest instance of the visualization to be the final instance (FINAL) or until a maximum number of visualizations have been generated, at which point the process is automatically terminated.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements visualization process 806, which is (are) representative of the visualization processes discussed with respect to the preceding Figures, such as process 200 and workflow 700. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including visualization process 806) may be implemented in program instructions and among other functions may, when executed by processing system 802, direct processing system 802 to operate as described with respect to the various operational scenarios, sequences, and processes illustrated herein. For example, software 805 may include program instructions for implementing a visualization process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support visualization generation in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
a) receive a user request to generate a visualization;
b) submit a first prompt to a foundation model to obtain code for generating an instance of the visualization requested by the user;
c) generate an instance of the visualization using the code;
d) submit the instance of the visualization to an image model to obtain a description of the instance; and
e) submit a second prompt to the foundation model to obtain an evaluation of the instance of the visualization with respect to the visualization requested by the user, wherein the second prompt includes the description produced by the image model.

2. The computing apparatus of claim 1, wherein the program instructions further direct the computing apparatus to iteratively repeat steps b-e until the evaluation determines that the instance of the visualization satisfies the user request.

3. The computing apparatus of claim 2, wherein the program instructions further direct the computing apparatus to display the instance of the visualization in a user interface.

4. The computing apparatus of claim 3, wherein the program instructions further direct the computing apparatus to display the evaluation in the user interface in association with the instance of the visualization.

5. The computing apparatus of claim 2, wherein the program instructions further direct the computing apparatus to display the instance of the visualization in the user interface when a number of instances of the visualization reaches a maximum value.

6. The computing apparatus of claim 1, wherein the program instructions further direct the computing apparatus to:
submit a third prompt to the foundation model to obtain a second code for generating a second instance of the visualization, wherein the third prompt includes the evaluation of the instance of the visualization;
generate the second instance of the visualization using the second code;
submit the second instance of the visualization to the image model to obtain a description of the second instance of the visualization;
submit a fourth prompt to the foundation model to obtain an evaluation of the second instance of the visualization with respect to the visualization requested by the user, wherein the fourth prompt includes the description of the second instance of the visualization; and
display the second instance of the visualization in the user interface.

7. The computing apparatus of claim 1, wherein the code comprises Python code, and wherein to generate the instance of the visualization, the program instructions direct the computing apparatus to execute the code using a Python engine.

8. The computing apparatus of claim 1, wherein the user request is a natural language input from the user.

9. A method of operating a computing device comprising:
a) receiving a user request to generate a visualization;
b) submitting a first prompt to a foundation model to obtain code for generating an instance of the visualization requested by the user;
c) generating an instance of the visualization using the code;
d) submitting the instance of the visualization to an image model to obtain a description of the instance; and
e) submitting a second prompt to the foundation model to obtain an evaluation of the instance of the visualization with respect to the visualization requested by the user, wherein the second prompt includes the description produced by the image model.

10. The method of claim 9, further comprising iteratively repeating steps b-e until the evaluation determines that the instance of the visualization satisfies the user request.

11. The method of claim 10, further comprising displaying the instance of the visualization in a user interface.

12. The method of claim 11 further comprising displaying the evaluation in the user interface in association with the instance of the visualization.

13. The method of claim 9, further comprising displaying the instance of the visualization in the user interface when a number of instances of the visualization reaches a maximum value.

14. The method of claim 9, further comprising:
submitting a third prompt to the foundation model to obtain a second code for generating a second instance of the visualization, wherein the third prompt includes the evaluation of the instance of the visualization;
generating the second instance of the visualization using the second code;
submitting the second instance of the visualization to the image model to obtain a description of the second instance of the visualization;
submitting a fourth prompt to the foundation model to obtain an evaluation of the second instance of the visualization with respect to the visualization requested by the user, wherein the fourth prompt includes the description of the second instance of the visualization; and
displaying the second instance of the visualization in the user interface.

15. The method of claim 9, wherein the code comprises Python code, and wherein generating the instance of the visualization comprises executing the code using a Python engine.

16. One or more computer readable storage media having program instructions stored thereon that, when executed by one or more processors, direct a computing device to at least:
a) receive a user request to generate a visualization;
b) submit a first prompt to a foundation model to obtain code for generating an instance of the visualization requested by the user;
c) generate an instance of the visualization using the code;
d) submit the instance of the visualization to an image model to obtain a description of the instance; and
e) submit a second prompt to the foundation model to obtain an evaluation of the instance of the visualization with respect to the visualization requested by the user, wherein the second prompt includes the description produced by the image model.

17. The one or more computer readable storage media of claim 16, wherein the program instructions further direct the computing device to iteratively repeat steps b-e until the evaluation determines that the instance of the visualization satisfies the user request.

18. The one or more computer readable storage media of claim 17, wherein the program instructions further direct the computing device to display the evaluation in a user interface in association with the instance of the visualization.

19. The one or more computer readable storage media of claim 16, wherein the code comprises Python code, and wherein to generate the instance of the visualization, the program instructions direct the computing device to execute the code using a Python engine.

20. The one or more computer readable storage media of claim 16, wherein the user request is a natural language input from the user.
